(19) United States
(12) Patent Application Publication
(10) Pub. No.: US 2014/0212860 A1
(43) Pub. Date: Jul. 31, 2014

(54) VIRTUAL-REALITY SIMULATOR TO PROVIDE TRAINING FOR SENTINEL LYMPH NODE SURGERY USING IMAGE DATA AND DATABASE DATA

(71) Applicant: Novadaq Technologies Inc., Mississauga (CA)

(72) Inventors: Chuanyong Bai, Poway, CA (US); Joel Kindem, San Diego, CA (US); Steve Yarnall, Poway, CA (US); Richard Conwell, Escondido, CA (US)

(73) Assignee: NOVADAQ TECHNOLOGIES INC., Mississauga (CA)

(21) Appl. No.: 14/170,526

(22) Filed: Jan. 31, 2014

Related U.S. Application Data
(60) Provisional application No. 61/758,836, filed on Jan. 31, 2013.

(51) Int. Cl. G09B 23/28

(52) U.S. Cl. CPC G09B 23/28
USPC 434/262

(57) ABSTRACT

A virtual-reality method for surgical training simulates the task of detecting sentinel lymph nodes using a nuclear uptake probe. The simulator can be used with lymphoscintigraphic clinical imaging data to provide patient-specific training scenarios. In yet another embodiment, the apparatus can use a database representing mathematical phantoms to simulate different patient sizes, node distributions, node uptakes, and combinations thereof.

### CROSS-REFERENCE TO RELATED APPLICATION

This application claims the benefit under 35 U.S.C. §119 of earlier-filed U.S. Provisional Patent Application No. 61/758,836, filed Jan. 31, 2013, the disclosure of which is incorporated herein by reference.

### TECHNICAL FIELD

The present disclosure relates generally to the field of surgical training simulators. More specifically, the disclosure relates to methods of computerized surgical training in the use of handheld probes that detect concentrations of injected radionuclides to localize sentinel nodes.

### BACKGROUND

In medicine, hand-held nuclear uptake probes are used to detect the gamma rays emitted by concentrations of injected radionuclides such as Tc-99 sulfur colloid. These probes are commonly used to guide sentinel lymph node surgeries using their audible output and count-rate readout to locate structures and regions where injected radionuclides are present. In sentinel lymph node surgery, the difficulty of the detection task is often affected by patient-specific factors such as the location of the sentinel node(s) relative to the radionuclide injection site, the amount of adipose tissue present, and the uptake in the nodes.

Surgeons starting to perform sentinel node procedures will usually have to undergo a training period during which they perform standard sentinel lymph node surgeries under the guidance of an experienced surgeon. Such clinical-based skills training has the limitation that few or perhaps none of the training cases may present a difficult detection task.

Lymphoscintigraphy is a means of imaging (using a gamma camera) the gamma ray emissions coming from the distribution of radionuclides within a patient's lymphatic system draining the injection site of a radionuclide. These images can be acquired in 2D or 3D format.

A sentinel node surgical training system must provide the trainee with the distribution of radionuclides co-registered to some anatomy. As a lymphoscintigram produces only an image of the gamma ray emissions of the distribution of the radionuclide, and not the patient's anatomy, they are difficult to relate to the patient's habitus. Therefore additional anatomical imaging that is co-registered with the nuclear image is required.

In 2D format, a recently developed gamma camera and combined depth camera enables the nuclear 2D image to be co-registered with a surface rendering of the anatomy.

In 3D format, the nuclear-anatomical image can be acquired using a SPECT/CT system where the 3D SPECT image of the gamma ray emissions of the distribution of radionuclides is co-registered with the anatomical CT images.

Alternatively, a totally mathematical nuclear-anatomical phantom can be created by modeling the gamma ray-attenuation characteristics of a prescribed anatomy in physical space, then prescribing the locations and concentrations of radionuclide within the anatomy, and then modeling the gamma ray emissions from the radionuclide in physical space.

Surgery typically involves the use of hand-held tools and surgical training typically involves learning how to use the tool. Therefore virtual-reality surgical simulators typically consist of a means of spatially tracking a dummy tool held in the hand of the surgical trainee while the trainee looks at a computer generated image of the anatomy in the region of the surgical site. An image of the tool is accurately rendered in the anatomical image space, and the virtual tool moves within the anatomical image in response to a dummy tool's and the associated trainee's hand movements. More sophisticated simulators may also provide haptic feedback to the tool held by the surgical trainee. The degree of realism of the computer-generated images may also vary from a simple 2D image to 3D images generated by various means.

Sentinel node surgical training with radio-anatomical models or computerized simulators has been used as a means of increasing skill and assessing competence before application to real patient cases. However these training devices have several shortcomings.

The radio-anatomical models typically require the preparation of radionuclides and their placement within a physical anatomical phantom as described by: Keshtgar M. R., et. al. “A training simulator for sentinel node biopsy in breast cancer: a new standard.” Eur. J. Surg. Oncol., 2005. This time-consuming task is burdened with the need for radioactive material handling oversight and fraught with the risk of a radioactive spill. The range of anatomical variation of the phantoms used is also limited and may not include the full range that may be encountered in actual patients, thus presenting limitations as a training system.

Computerized simulators using anatomical phantoms do not require the preparation of radionuclides and can create a wide range of virtual radionuclide distribution as described by: Britten A., et. al. “Computerized Gamma Probe Simulator to Train Surgeons in the Localization of Sentinel Nodes.” Nucl. Med. Commun., 2007. However, such computerized simulators may not adequately emulate gamma ray emissions encountered in a sentinel node procedure due to programming limitations. Importantly, the effects of the location of the sentinel node(s) relative to the radionuclide injection site and the amount of adipose tissue present may not be accurately simulated.

### SUMMARY OF THE INVENTION

The present invention is intended to improve the realism of a virtual reality surgical simulator simulating a nuclear uptake probe-guided sentinel lymph node surgery. Of particular interest is increasing the realism of probe's response to the gamma rays emitted by the distribution of radionuclides within the simulated anatomy.

Lymphoscintigraphic and anatomical imaging data is used by the simulator. In 2D form co-registered lymphoscinticraphy and co-registered anatomical image data are loaded into the computerized simulator. Within the simulator environment the trainee moves the probe above the anatomical image and orthogonal to the gamma image and the probe's spatial position is measured. The simulator then calculates the uptake probe's gamma ray detection response for the probe's spatial positions. The simulator then produces the audio and visual feedback of the probe response to the gamma rays detected. In 3D form co-registered lymphoscinticraphy and co-registered CT acquired anatomical image data are loaded into the computerized simulator. Within the simulator environment the trainee moves the probe in the co-registered image space and the probe's spatial position is measured. The simulator then calculates the uptake probe's gamma ray detection response for the probe's spatial positions. The simulator then produces the audio and visual feedback of the probe response to the gamma rays detected.

Alternatively, a virtual human body, radionuclide injection site and sentinel node location(s) is defined. This task could be performed externally to, or within, the simulator. If performed externally to the simulator, this data is then loaded into the simulator. Within the simulator environment the trainee moves the probe above and or within the virtual body's habitus and the probe's spatial position is measured. The simulator then calculates the uptake probe's gamma ray detection response for the probe's spatial positions. The simulator then produces the audio and visual feedback of the probe response to the gamma rays detected.

### BRIEF DESCRIPTION OF THE DRAWINGS

FIG. 1 shows a flow chart of the method of using 2D lymphoscintigraphy images and a co-registered depth camera image of the body habitus according to an embodiment of the invention.

FIG. 2 shows a flow chart of the method of using 3D SPECT lymphoscintigraphy and a co-registered CT anatomical image according to an embodiment of the invention.

FIG. 3 shows a flow chart of a method of using a mathematical phantom according to an embodiment of the invention.

FIG. 4 is a schematic illustration of a general system for implementing principles of the disclosure.

FIG. 5 is a block diagram of an exemplary sentinel node simulator according to an embodiment of the disclosure.

### DETAILED DESCRIPTION

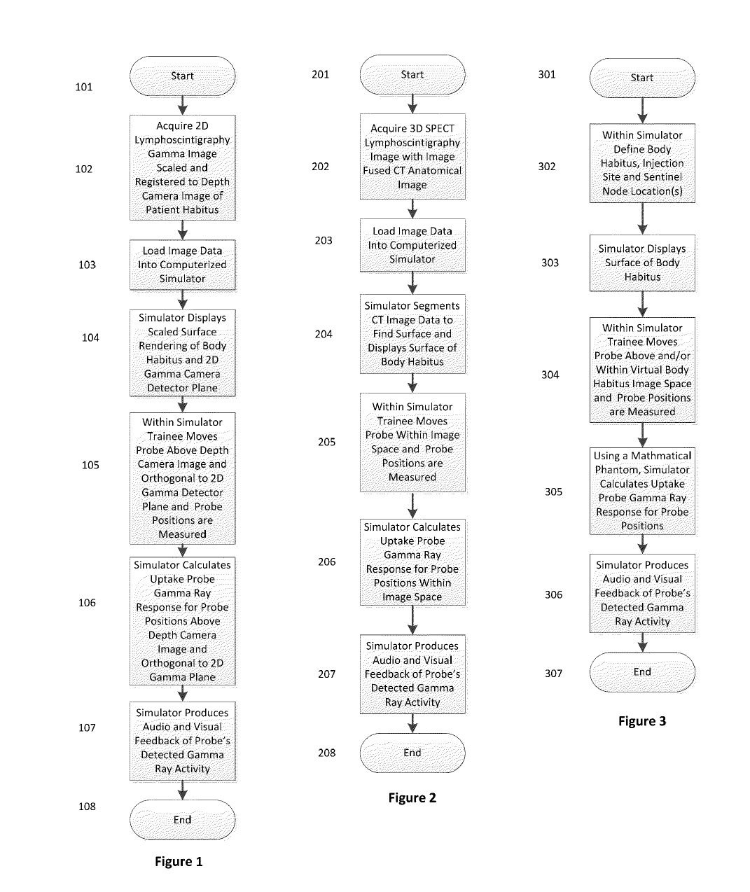

FIG. 1 depicts the steps in the method of using the data from 2D lymphoscintigraphy images and a surface rendering of the patient's body habitus in a virtual-reality surgical simulator. In step 102, using the inventive combined gamma camera and depth camera, planar lymphoscintigraphy images are acquired from a patient using a gamma camera. A surface rendering of the patient's body habitus encompassing the area of the gamma camera image is also acquired using the depth camera and the data sets scaled to the real world are co-registered in the combined gamma camera and depth camera. In step 103 the co-registered data sets, which together form a nuclear-anatomical computational database, along with the gamma camera's collimator characteristics, are loaded into the computerized simulator. This loading task may be performed via a network connection between the gamma camera/depth camera device or by transfer via a physical medium such as a storage disk or flash drive. In step 104, using the scaled surface rendering data set, the simulator generates and displays to the trainee a virtual image of the body habitus as well as the plane of orientation of the gamma camera's detector. In step 105, while viewing the virtual body habitus, the trainee moves a virtually generated uptake probe over the virtual surface of the body habitus and orthogonally to the plane of the gamma camera. The relative motion of this virtual probe to the scaled image is accomplished by the trainee physically moving with his hand a dummy probe that mimics the shape and feel of a real uptake probe. The spatial location and orientation of this dummy probe is tracked by the simulator using either optical, electromagnetic, or mechanical means. The scale of the space within which the hand held dummy probe is moved is set by the simulator to be one-to-one with the real world scale of the data sets from the combined gamma camera and depth camera. The trainee thus experiences an absolute range of motion of the hand held dummy probe equal to the real world while the range of motion of the displayed virtual probe is only some proportion thereof. In step 106, using the virtual uptake probe's detector response (which may be changed in the simulator by the trainee), the gamma camera's collimator characteristics, the virtual probes spatial location relative to the gamma camera plane and the data set of the counts in the image plane of the gamma camera image, the simulator algorithm calculates the number of gamma rays that would be detected by the virtual probe. In step 107 the simulator produces an audio output and a visual image (within the virtual image viewed by the trainee) of the virtual uptake probes gamma ray detection response.

FIG. 2 depicts the steps in a method of using 3D-SPECT lymphoscintigraphy image and a co-registered CT anatomical image in a virtual-reality surgical simulator. In step 202, a SPECT lymphoscintigraphy image and a co-registered CT image scaled to the real world are acquired from a patient using a SPECT/CT gamma camera. In step 203 these co-registered, scaled data sets, which together form a nuclear-anatomical computational database, along with the gamma camera's collimator characteristics, are loaded into the computerized simulator. This loading task may be performed via a network connection between the SPECT/CT gamma camera or by transfer via a physical medium such as a storage disk or flash drive. In step 204, using the scaled CT image data set the simulator segments the CT data to find the surface of the body habitus and then displays to the trainee a virtual image of the body habitus. In step 205, while viewing the virtual body habitus, the trainee moves over and under the virtual surface of the body habitus a virtually generated uptake probe. The relative motion of this virtual probe to the scaled image is accomplished by the trainee physically moving with his hand a dummy probe that mimics the shape and feel of a real uptake probe. The spatial location and orientation of this dummy probe is tracked by the simulator using either optical, electromagnetic, or mechanical means. The scale of the space within which the hand held dummy probe is moved is set by the simulator to be one-to-one with the real world scale of the data sets from the combined gamma camera and CT images. The trainee thus experiences an absolute range of motion of the hand held dummy probe equal to the real world while the range of motion of the displayed virtual probe is only some proportion thereof. In step 206, using the virtual uptake probe's detector response (which may be changed in the simulator by the trainee), the gamma camera's collimator characteristics, the virtual probes spatial location relative to the SPECT data image data sets and the data set of the counts in the SPECT image of the gamma camera image, the simulator calculates the number of gamma rays that would be detected by the virtual probe. In step 207 the simulator algorithm produces an audio output and a visual image (the virtual image viewed by the trainee) of the virtual uptake probes gamma ray detection response.

FIG. 3 depicts the steps in a method of using mathematical phantom's output data sets in a virtual-reality surgical simulator. In step 302, the input database of a mathematical phantom within a virtual reality surgical simulator is loaded with a scaled, virtual, tissue equivalent human body, a radionuclide injection site and the sentinel node location(s) with their radionuclide uptake. In step 303 the body habitus is of the virtual human body is displayed by the simulator to the trainee. In step 304, while viewing the virtual body habitus, the trainee moves over and under the virtual surface of the scaled body habitus a virtually generated uptake probe. The relative motion of this virtual probe to the scaled image is accomplished by the trainee physically moving with his hand a dummy probe that which mimics the shape and feel of a real uptake probe. The spatial location and orientation of this dummy probe is tracked by the simulator using either optical, electromagnetic, or mechanical means. The scale of the space within which the hand held dummy probe is moved is set by the simulator to be one-to-one with the real world scale of the data sets from the scaled, virtual, tissue equivalent human body defined. The trainee thus experiences an absolute range of motion of the hand held dummy probe equal to the real world while the range of motion of the displayed virtual probe is only some proportion thereof. In step 305, using the virtual uptake probe's detector response (which may be changed in the simulator by the trainee), the virtual probes spatial location relative to the virtual human body, the virtual human body's tissue density distribution, the spatial location and injected dose of the injections site and the spatial location and radionuclide uptake of the sentinel node(s), the simulator using the mathematical phantom calculates the number of gamma rays that would be detected by the virtual probe. In step 306 the simulator produces an audio output and a visual image (within the virtual image viewed by the trainee) of the virtual uptake probes gamma ray detection response. This embodiment has the advantage of being able to model the scatter of the tissue within the body to more realistically simulate the effects of gamma rays scattered from the injection site into the uptake probe at the location of the sentinel node(s).

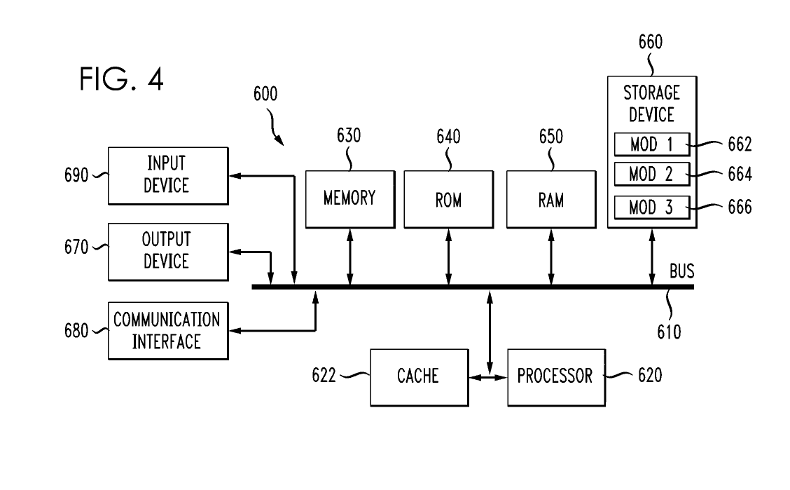

Referring now to FIG. 4, which illustrates a general system 600, all or part of which can be used to implement the principles disclosed herein. With reference to FIG. 4, an exemplary computer system and/or a simulator 600 includes a processing unit (for example, a central processing unit (CPU) or processor) 620 and a system bus 610 that couples various system components, including the system memory 630 such as read only memory (ROM) 640 and random access memory (RAM) 650, to the processor 620. The system 600 can include a cache 622 of high-speed memory connected directly with, in close proximity to, or integrated as part of the processor 620.

The system 600 copies data from the memory 630 and/or the storage device 660 to the cache 622 for quick access by the processor 620. In this way, the cache provides a performance boost that avoids processor 620 delays while waiting for data. These and other modules can control or be configured to control the processor 620 to perform various operations or actions. Other system memory 630 can be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability.

The processor 620 can include any general purpose processor and a hardware module or software module, such as module 1 662, module 2 664, and module 3 666 stored in storage device 660, configured to control the processor 620 as well as a special-purpose processor where software instructions are incorporated into the processor. The processor 620 can be a self-contained computing system, containing multiple cores or processors, a bus, memory controller, cache and the like. A multi-core processor can be symmetric or asymmetric. The processor 620 can include multiple processors, such as a system having multiple, physically separate processors in different sockets, or a system having multiple processor cores on a single physical chip.

Similarly, the processor 620 can include multiple distributed processors located in multiple separate computing devices, but working together such as via a communications network. Multiple processors or processor cores can share resources such as memory 630 or the cache 622, or can operate using independent resources. The processor 620 can include one or more of a state machine, an application specific integrated circuit (ASIC), or a programmable gate array (PGA) including a field PGA.

The system bus 610 can be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 can further include storage devices 660 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 660 can include software modules 662, 664, 666 for controlling the processor 620. The system 600 can include other hardware or software modules. The storage device 660 can be connected to the system bus 610 by a drive interface. The drives and the associated computer-readable storage devices can provide nonvolatile storage of computer-readable instructions, data structures, program modules and other data for the computing device 600. In one aspect, a hardware module that performs a particular function can include the software component stored in a tangible computer-readable storage device in connection with the necessary hardware components, such as the processor 620, bus 610, display 670 and the like to carry out a particular function. In another aspect, the system can use a processor and computer-readable storage device to store instructions which, when executed by the processor, cause the processor to perform operations, a method or other specific actions. The basic components and appropriate variations can be modified depending on the type of device, such as whether the device 600 is a small, handheld or portable computing device, a desktop computer, or a computer server. When the processor 620 executes instructions to perform “operations”, the processor 620 can perform the operations directly and/or facilitate, direct, or cooperate with another device or component to perform the operations.

Although the exemplary embodiment(s) described herein employs the hard disk 660, other types of computer-readable storage devices which can store data that are accessible by a computer, such as magnetic cassettes, flash memory cards, digital versatile disks (DVDs), cartridges, random access memories (RAMs) 650, read only memory (ROM) 640, a cable containing a bit stream and the like may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 620. The functions these blocks represent can be provided through the use of either shared or dedicated hardware, including, but not limited to, hardware capable of executing software and hardware, such as a processor 620, that is purpose-built to operate as an equivalent to software executing on a general purpose processor. For example the functions of one or more processors presented in FIG. 4 can be provided by a single shared processor or multiple processors. (Use of the term “processor” should not be construed to refer exclusively to hardware capable of executing software.) Illustrative embodiments can include microprocessor and/or digital signal processor (DSP) hardware, read-only memory (ROM) 640 for storing software performing the operations described below, and random access memory (RAM) 650 for storing results. Very large scale integration (VLSI) hardware embodiments, as well as custom VLSI circuitry in combination with a general purpose DSP circuit, can also be provided.

The logical operations of the various embodiments can be implemented as: (1) a sequence of computer implemented steps, operations, or procedures running on a programmable circuit within a general use computer; (2) a sequence of computer implemented steps, operations, or procedures running on a specific-use programmable circuit; and/or (3) interconnected machine modules or program engines within the programmable circuits. The system 600 shown in FIG. 4 can practice all or part of the recited methods, can be a part of the recited systems, and/or can operate according to instructions in the recited tangible computer-readable storage devices. Such logical operations can be implemented as modules configured to control the processor 620 to perform particular functions according to the programming of the module. For example, FIG. 4 illustrates three modules Mod1 662, Mod2 664, and Mod3 666 that are modules configured to control the processor 620. These modules may be stored on the storage device 660 and loaded into RAM 650 or memory 630 at runtime or may be stored in other computer-readable memory locations.

One or more parts of the example computing device 600, up to and including the entire computing device 600, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type can implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 620 can include all types of processors disclosed herein, including a virtual processor. However, when referring to a virtual processor, the processor 620 can include the software components associated with executing the virtual processor in a virtualization layer and underlying hardware necessary to execute the virtualization layer. The system 600 can include a physical or virtual processor 620 that receives instructions stored in a computer-readable storage device, which cause the processor 620 to perform certain operations. When referring to a virtual processor 620, the system also includes the underlying physical hardware executing the virtual processor 620.

Embodiments within the scope of the present disclosure may also include tangible and/or non-transitory computer-readable storage devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules can include routines, programs, components, data structures, objects, and the functions inherent in the design of special-purpose processors and so forth that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure can be practiced in network computing environments with many types of computer system configurations, including personal computers, hand-held devices, multi-processor systems, microprocessor-based or programmable consumer electronics, network PCs, minicomputers, mainframe computers, and the like. Embodiments can also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

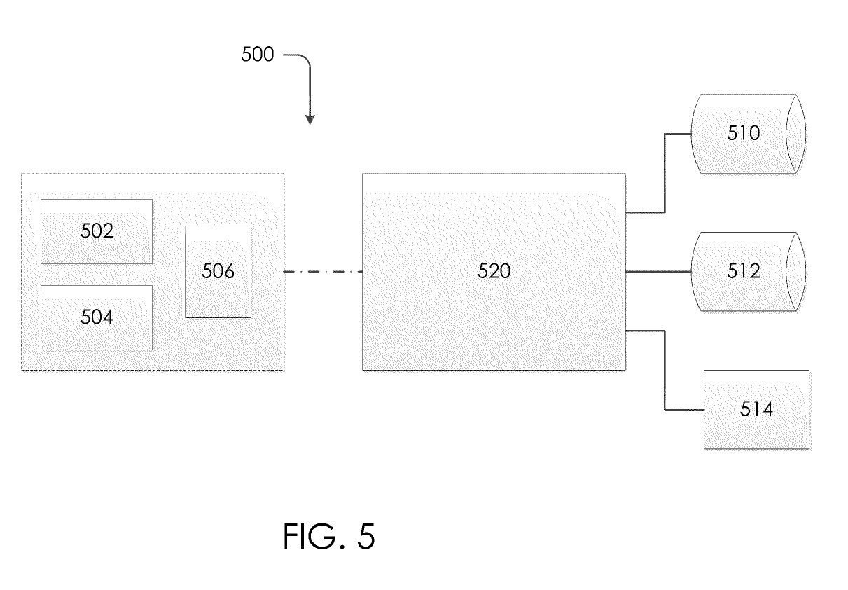

Referring now to FIG. 5, an exemplary embodiment of a sentinel node simulator 500, which can be configured as described above in connection with system 600. The simulator 500 can include a handheld probe 502 and a nuclear uptake probe 504 as input devices. The handheld probe 502, for example, a dummy nuclear uptake probe, is movable in physical space with its position being determined by a tracking arrangement or tracking means 506. The nuclear uptake probe 504 is correlated and scaled to physical space with its virtual position controlled by the handheld probe 502 with its tracking means 506. In an exemplary embodiment, the simulator 500 includes a nuclear-anatomical computational database or storage device 510 derived, for example, from spatially co-registered lymphoscintigraphic imaging data and anatomical imaging data. The lymphoscintigraphic imaging data depicts a concentration distribution of radionuclide in a sentinel node procedure, and the anatomical imaging data depicts a body habitus scaled to physical space. The simulator 500 also includes a nuclear uptake probe-response database or storage device 512.

The sentinel node simulator 500 includes a computerized simulator 520 such as, for example, a processor. The computerized simulator 520 can be configured to calculate the nuclear probe's response to the concentration distribution of radionuclide based on the location of the handheld probe 502 in physical space. The sentinel node simulator 500 can include a virtual-reality interface 514, or output device, configured to display the depicted body habitus in relation to the nuclear probe 504 and configured to provide feedback correlating to the nuclear probe's detector response.

In some aspects, the simulator 500 can execute an algorithm, or instructions, that calculates the number of gamma rays that would be detected by the uptake probe 504 by considering the response of the probe, the gamma camera's collimator characteristics, the virtual probes spatial location relative to the gamma camera plane, and the data set of the counts in the image plane of the gamma camera image.

It should be understood that any or all of the aforementioned components of the sentinel node simulator 500 can be configured to communicate with one another via a wired connection (e.g., LAN, intranet, internet, USB, etc.) and/or wirelessly. It should also be understood that the aforementioned components can be physically embodied in separate structures or can be combined into structures. For example, in the two probes 502, 504 and the tracking arrangement can be embodied in a single handheld unit. As another example, the simulator 520, both databases 510, 512, and the interface 514 can be embodied in a single physical unit or can embodied in two or more physical structures.

While the invention has been illustrated and described in connection with exemplary embodiments described in detail, it is not intended to be limited to the details shown since various modifications may be made without departing in any way from the scope of the present invention. The embodiments chosen and described explain the principles of the invention and its practical application and do thereby enable a person of skill in the art to best utilize the invention and its various embodiments.

What is claimed is:

1. A sentinel node simulator comprising:
a nuclear-anatomical computational database derived from spatially co-registered lymphoscintigraphic imaging data depicting a concentration distribution of radionuclide in a sentinel node procedure, and anatomical imaging data depicting a body habitus scaled to physical space;
a handheld probe movable in physical space with its position being determined by a tracking means;
a nuclear uptake probe correlated and scaled to physical space with its virtual position controlled by the handheld probe with its tracking means;
a nuclear uptake probe-response database;
a computerized simulator configured to calculate the nuclear probe's response to the concentration distribution of radionuclide based on the location of the handheld probe in physical space; and
a virtual-reality interface configured to display the depicted body habitus in relation to the nuclear probe and configured to provide feedback correlating to the nuclear probe's detector response.

2. The sentinel node simulator of claim 1 wherein the lymphoscintigraphic imaging data is derived from planar (2D) lymphoscintigraphy.

3. The sentinel node simulator of claim 1 wherein the lymphoscintigraphic imaging data is derived from a SPECT (3D) lymphoscintigraphy.

4. The sentinel node simulator of claim 1 wherein the anatomical imaging data is derived from a depth camera image.

5. The sentinel node simulator of claim 1 wherein the anatomical imaging data is derived from a CT image.

6. A training method for sentinel node surgery comprising:
providing a sentinel node simulator comprising:
a nuclear-anatomical computational database derived from spatially co-registered lymphoscintigraphic imaging data depicting a concentration distribution of radionuclide in a sentinel node procedure, and anatomical imaging data depicting a body habitus scaled to physical space;
a handheld probe movable in physical space with its position being determined by a tracking means;
a nuclear uptake probe correlated and scaled to physical space with its virtual position controlled by the handheld probe with its tracking means;
a nuclear uptake probe-response database;
a computerized simulator configured to calculate the nuclear probe's response to the concentration distribution of radionuclide based on the location of the handheld probe in physical space; and
a virtual-reality interface configured to display the depicted body habitus in relation to the nuclear probe and configured to provide feedback correlating to the nuclear probe's detector response; and
providing instructions for use of the sentinel node simulator.

7. The training method of claim 6, wherein the lymphoscintigraphic imaging data of the sentinel node simulator is derived from planar (2D) lymphoscintigraphy.

8. The training method of claim 6, wherein the lymphoscintigraphic imaging data of the sentinel node simulator is derived from a SPECT (3D) lymphoscintigraphy.

9. The sentinel node simulator of claim 6, wherein the anatomical imaging data of the sentinel node simulator is derived from a depth camera image.

10. The sentinel node simulator of claim 6, wherein the anatomical imaging data of the sentinel node simulator is derived from a CT image.

11. A sentinel lymph node surgery simulator comprising:
a nuclear-anatomical computational database derived from spatially co-registered lymphoscintigraphic imaging data depicting a concentration distribution of radionuclide in a sentinel node procedure, and anatomical imaging data depicting a body habitus scaled to physical space;
a handheld dummy nuclear uptake probe movable in physical space with its position being determined by a tracking means;
a virtual nuclear uptake probe correlated and scaled to physical space with its virtual position controlled by the handheld dummy probe with its tracking means;
an algorithm that calculates the number of gamma rays that would be detected by the virtual probe by considering: the response of the probe, the gamma camera's collimator characteristics, the virtual probes spatial location relative to the gamma camera plane and the data set of the counts in the image plane of the gamma camera image; and
a virtual-reality interface configured to display the depicted body habitus in relation to the nuclear probe and configured to provide feedback correlating to the nuclear probe's detector response.

12. The sentinel lymph node surgery simulator of claim 11 wherein the lymphoscintigraphic imaging data is derived from planar (2D) lymphoscintigraphy.

13. The sentinel lymph node surgery simulator of claim 11 wherein the lymphoscintigraphic imaging data is derived from a SPECT (3D) lymphoscintigraphy.

14. The sentinel lymph node surgery simulator of claim 11 wherein the anatomical imaging data is derived from a depth camera image.

15. The sentinel lymph node surgery simulator of claim 11 wherein the anatomical imaging data is derived from a CT image.

16. The sentinel lymph node surgery simulator of claim 11 wherein the anatomical imaging data and the lymphoscintigraphic imaging data is derived from a mathematical model.
